(19) United States
(12) Patent Application Publication
(10) Pub. No.: US 2020/0153046 A1
(43) Pub. Date: May 14, 2020

(54) BATTERY ELECTROLYTES COMPRISING 1,3-DIMETHOXYPROPANE AND BATTERY CELLS UTILIZING THE SAME

(71) Applicant: GM GLOBAL TECHNOLOGY OPERATIONS LLC, DETROIT, MI (US)

(72) Inventors: Ning Kang, Troy, MI (US); Li Yang, Troy, MI (US); Mei Cai, Bloomfield Hills, MI (US)

(21) Appl. No.: 16/188,733

(22) Filed: Nov. 13, 2018

(51) Int. Cl. H01M 10/0569; H01M 10/0525; H01M 4/131; H01M 4/136

(52) U.S. Cl. CPC H01M 10/0569; H01M 10/0525; H01M 2300/0037; H01M 4/136; H01M 2220/20; H01M 4/131

(57) ABSTRACT

Provided are 1,3-dimethoxypropane (DMP)-containing battery electrolytes, and lithium ion batteries utilizing the same. The batteries comprise an electrolyte including DMP, a lithium anode disposed within the electrolyte, and a cathode disposed within the electrolyte. The cathode can comprise a lithium metal oxide or a chalcogen material. The lithium metal oxide can be LiNiₓCo_{y}Mn_{z}O₂ or lithium iron phosphate. The chalcogen material can include sulfur and/or selenium. The electrolyte can include one or more co-solvents including tetrahydrofuran, 2-methyltetrahydrofuran and 1,3-dioxolane. The electrolyte can include one or more lithium salts, including LiClO₄, LiAlCl₄, LiI, LiBr, LiSCN, LiBF₄, LiB(C₆H₅)₄LiAsF₆, LiCF₃SO₃, LiN(CF₃SO₂)₂, and LiPF₆.

### INTRODUCTION

Lithium ion batteries describe a class of rechargeable batteries in which lithium ions move between a negative electrode (i.e., anode) and a positive electrode (i.e., cathode). Liquid and polymer electrolytes can facilitate the movement of lithium ions between the anode and cathode. Lithium-ion batteries are growing in popularity for defense, automotive, and aerospace applications due to their high energy density and ability to undergo successive charge and discharge cycles.

### SUMMARY

A lithium battery cell is provided, and has an electrolyte including 1,3-dimethoxypropane, a lithium anode disposed within the electrolyte, and a lithium metal oxide cathode disposed within the electrolyte. The electrolyte further comprises a co-solvent. The co-solvent comprises one or more of tetrahydrofuran, 2-methyltetrahydrofuran and 1,3-dioxolane. The electrolyte further comprises a lithium salt. The lithium salt comprises LiN(FSO₂)₂. The lithium salt comprises one or more of LiClO₄, LiAlCl₄, LiI, LiBr, LiSCN, LiBF₄, LiB(C₆H₅)₄LiAsF₆, LiCF₃SO₃, LiN(CF₃SO₂)₂, and LiPF₆. The lithium metal oxide comprises LiNiₓCo_{y}Mn_{z}O₂. The lithium metal oxide comprises lithium iron phosphate. The electrolyte further comprises dissolved LiN(FSO₂)₂ and optionally a 1,3-dioxolane co-solvent, and the lithium metal oxide comprises LiNi_{0.6}Co_{0.2}Mn_{0.2}O₂.

A lithium-chalcogen battery cell is provided, and has an electrolyte including 1,3-dimethoxypropane, a lithium anode disposed within the electrolyte, and a chalcogen cathode disposed within the electrolyte. The electrolyte further comprises a co-solvent. The co-solvent comprises one or more of tetrahydrofuran, 2-methyltetrahydrofuran and 1,3-dioxolane. The electrolyte further comprises a lithium salt. The lithium salt comprises LiN(FSO₂)₂. The lithium salt comprises one or more of LiClO₄, LiAlCl₄, LiI, LiBr, LiSCN, LiBF₄, LiB(C₆H₅)₄LiAsF₆, LiCF₃SO₃, LiN(CF₃SO₂)₂, and LiPF₆. The cathode comprises one or more sulfur materials and/or one or more selenium materials. The cathode further comprises a binder and a conductive filler. The electrolyte further comprises one or more of dissolved LiN(FSO₂)₂ and dissolved LiNO₃ and optionally a 1,3-dioxolane co-solvent, and the cathode comprises sulfur, carbon and a binder.

An electrolyte for a lithium ion battery is provided, and includes 1,3-dimethoxypropane (DMP). The electrolyte can further include one or more of tetrahydrofuran, 2-methyltetrahydrofuran and 1,3-dioxolane.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a lithium battery cell, according to one or more embodiments;

FIG. 2 illustrates a schematic diagram of a hybrid-electric vehicle, according to one or more embodiments;

FIG. 3A illustrates a graph the capacity decrease of a 1,2-dimethoxyethane-containing battery cell over charge/discharge 10 cycles, according to one or more embodiments;

FIG. 3B illustrates a graph the capacity decrease of a 1,3-dimethoxypropane-containing battery cell over 10 charge/discharge cycles, according to one or more embodiments;

FIG. 4A illustrates a graph of the charge voltage and discharge voltage of a battery for 140 cycles; and

FIG. 4B illustrates a graph of the capacity of a battery cell for each of the 140 charge/discharge cycles.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are battery electrolytes and batteries utilizing the same, wherein the electrolyte comprises 1,3-dimethoxypropane (DMP). DMP exhibits higher electrochemical stability and a higher boiling point than conventional solvents such as 1,2-dimethoxyethane (DME), and improves the safety of appurtenant battery cells and packs by eliminating or reducing the occurrence of undesirable gassing and thermal runaway.

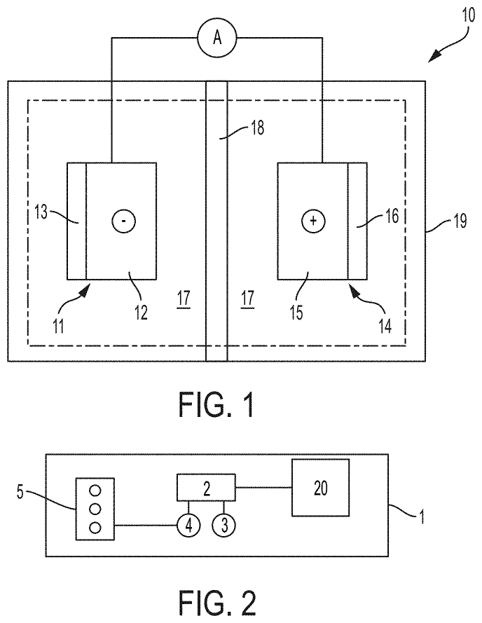

FIG. 1 illustrates a lithium battery cell 10 comprising a negative electrode (i.e., the anode) 11, a positive electrode (i.e., the cathode) 14, an electrolyte 17 operatively disposed between the Anode 11 and the cathode 14, and a separator 18. Anode 11, cathode 14, and electrolyte 17 can be encapsulated in container 19, which can be a hard (e.g., metallic) case or soft (e.g., polymer) pouch, for example. The Anode 11 and cathode 14 are situated on opposite sides of separator 18 which can comprise a microporous polymer or other suitable material capable of conducting lithium ions and optionally electrolyte (i.e., liquid electrolyte). Electrolyte 17 is a liquid electrolyte comprising one or more lithium salts dissolved in a non-aqueous solvent comprising DMP and optionally one or more co-solvents, as will be described below. Anode 11 generally includes a current collector 12 and a lithium intercalation host material 13 applied thereto. Cathode 14 generally includes a current collector 15 and a lithium-based or chalcogen-based active material 16 applied thereto. For example, the battery cell 10 can comprise a chalcogen active material 16 or a lithium metal oxide active material 16, as will be described below. Active material 16 can store lithium ions at a higher electric potential than intercalation host material 13, for example. The current collectors 12 and 15 associated with the two electrodes are connected by an interruptible external circuit that allows an electric current to pass between the electrodes to electrically balance the related migration of lithium ions. Although FIG. 1 illustrates host material 13 and active material 16 schematically for the sake of clarity, host material 13 and active material 16 can comprise an exclusive interface between the anode 11 and cathode 14, respectively, and electrolyte 17.

Battery cell 10 can be used in any number of applications. For example, FIG. 2 illustrates a schematic diagram of a hybrid-electric vehicle 1 including a battery pack 20 and related components. A battery pack such as the battery pack 20 can include a plurality of battery cells 10. A plurality of battery cells 10 can be connected in parallel to form a group, and a plurality of groups can be connected in series, for example. One of skill in the art will understand that any number of battery cell connection configurations are practicable utilizing the battery cell architectures herein disclosed, and will further recognize that vehicular applications are not limited to the vehicle architecture as described. Battery pack 20 can provide energy to a traction inverter 2 which converts the direct current (DC) battery voltage to a three-phase alternating current (AC) signal which is used by a drive motor 3 to propel the vehicle 1. An engine 5 can be used to drive a generator 4, which in turn can provide energy to recharge the battery pack 20 via the inverter 2. External (e.g., grid) power can also be used to recharge the battery pack 20 via additional circuitry (not shown). Engine 5 can comprise a gasoline or diesel engine, for example.

Battery cell 10 generally operates by reversibly passing lithium ions between Anode 11 and cathode 14. Lithium ions move from cathode 14 to Anode 11 while charging, and move from Anode 11 to cathode 14 while discharging. At the beginning of a discharge, Anode 11 contains a high concentration of intercalated lithium ions while cathode 14 is relatively depleted, and establishing a closed external circuit between Anode 11 and cathode 14 under such circumstances causes intercalated lithium ions to be extracted from Anode 11. The extracted lithium atoms are split into lithium ions and electrons as they leave an intercalation host at an electrode-electrolyte interface. The lithium ions are carried through the micropores of separator 18 from Anode 11 to cathode 14 by the ionically conductive electrolyte 17 while, at the same time, the electrons are transmitted through the external circuit from Anode 11 to cathode 14 to balance the overall electrochemical cell. This flow of electrons through the external circuit can be harnessed and fed to a load device until the level of intercalated lithium in the negative electrode falls below a workable level or the need for power ceases. The arrows indicate that current is flowing out of Anode 11 and that current is flowing into cathode 14, and thus battery cell 10 is shown in a charging state.

Battery cell 10 may be recharged after a partial or full discharge of its available capacity. To charge or re-power the lithium ion battery cell, an external power source (not shown) is connected to the positive and the negative electrodes to drive the reverse of battery discharge electrochemical reactions. That is, during charging, the external power source extracts the lithium ions present in cathode 14 to produce lithium ions and electrons. The lithium ions are carried back through the separator by the electrolyte solution, and the electrons are driven back through the external circuit, both towards Anode 11. The lithium ions and electrons are ultimately reunited at the negative electrode, thus replenishing it with intercalated lithium for future battery cell discharge.

Lithium ion battery cell 10, or a battery module or pack comprising a plurality of battery cells 10 connected in series and/or in parallel, can be utilized to reversibly supply power and energy to an associated load device. Lithium ion batteries may also be used in various consumer electronic devices (e.g., laptop computers, cameras, and cellular/smart phones), military electronics (e.g., radios, mine detectors, and thermal weapons), aircrafts, and satellites, among others. Lithium ion batteries, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the battery cells, modules, and packs may be used in combination with a gasoline or diesel internal combustion engine to propel the vehicle (such as in hybrid electric vehicles), or may be used alone to propel the vehicle (such as in battery powered vehicles).

Returning to FIG. 1, electrolyte 17 conducts lithium ions between anode 11 and cathode 14, for example during charging or discharging the battery cell 10. The electrolyte 17 comprises DMP, optionally one or more co-solvents, and one or more lithium salts dissolved in the DMP and optionally the one or more co-solvents. Suitable co-solvents can comprise cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof. In one embodiment, electrolyte 17 comprises DMP and one or more of tetrahydrofuran, 2-methyltetrahydrofuran and 1,3-dioxolane. A non-limiting list of lithium salts that can be dissolved in the organic solvent(s) to form the non-aqueous liquid electrolyte solution include LiClO₄, LiAlCl₄, LiI, LiBr, LiSCN, LiBF₄, LiB(C₆H₅)₄LiAsF₆, LiCF₃SO₃, LiN(CF₃SO₂)₂, LiN(FSO₂)₂, LiPF₆, and mixtures thereof.

Host material 13 can include any lithium host material that can sufficiently undergo lithium ion intercalation, deintercalation, and alloying, while functioning as the negative terminal of the lithium ion battery 10. Host material 13 can also include a polymer binder material to structurally hold the lithium host material together. For example, in one embodiment, host material 13 can include graphite intermingled in one or more of of polyvinyldiene fluoride (PVdF), an ethylene propylene diene monomer (EPDM) rubber, carboxymethoxyl cellulose (CMC), and styrene, 1,3-butadiene polymer (SBR). Graphite and carbon materials are widely utilized to form the negative electrode because it exhibits favorable lithium ion intercalation and deintercalation characteristics, is relatively non-reactive, and can store lithium ions in quantities that produce a relatively high energy density. Other materials can also be used to form the host material 13, for example, including one or more of lithium titanate, silicon, silicon oxide, tin, and tin oxide. Anode current collector 12 can include copper, aluminum, stainless steel, or any other appropriate electrically conductive material known to skilled artisans. Anode current collector 12 can be treated (e.g., coated) with highly electrically conductive materials, including one or more of conductive carbon black, graphite, carbon nanotubes, carbon nanofiber, graphene, and vapor growth carbon fiber (VGCF), among others.

Active material 16 can include any lithium-based active material that can sufficiently undergo lithium intercalation and deintercalation while functioning as the positive terminal of battery cell 10. Active material 16 can also include a polymer binder material to structurally hold the lithium-based active material together. The active material 16 can comprise lithium transition metal oxides (e.g., layered lithium transitional metal oxides) or chalcogen materials. Cathode current collector 15 can include aluminum or any other appropriate electrically conductive material known to skilled artisans, and can be formed in a foil or grid shape. Cathode current collector 15 can be treated (e.g., coated) with highly electrically conductive materials, including one or more of conductive carbon black, graphite, carbon nanotubes, carbon nanofiber, graphene, and vapor growth carbon fiber (VGCF), among others.

Lithium transition metal oxides suitable for use as active material 16 can comprise one or more of spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃·(1−x)LiMO₂, where M is composed of any ratio of Ni, Mn and/or Co). A specific example of the layered nickel-manganese oxide spinel is xLi₂MnO₃·(1−x)Li(Ni_{1/3}Mn_{1/3}Co_{1/3})O₂. Other suitable lithium-based active materials include Li(Ni_{1/3}Mn_{1/3}Co_{1/3})O₂), LiNiO₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F). Other lithium-based active materials may also be utilized, such as LiNiₓM₁₋ₓO₂ (M is composed of any ratio of Al, Co, and/or Mg), LiNi₁₋ₓCo_{1-y}Mn_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material (HE-NMC, NMC or LiNiMnCoO₂). By “any ratio” it is meant that any element may be present in any amount. So, for example, M could be Al, with or without Co and/or Mg, or any other combination of the listed elements. In another example, anion substitutions may be made in the lattice of any example of the lithium transition metal based active material to stabilize the crystal structure. For example, any O atom may be substituted with an F atom. Please confirm that all relevant lithium metal oxide active materials are listed.

Chalcogen-based active material can include one or more sulfur and/or one or more selenium materials, for example. Sulfur materials suitable for use as active material 16 can comprise sulfur carbon composite materials, S₈, Li₂S₈, Li₂S₆, Li₂S₄, Li₂S₂, Li₂S, SnS₂, and combinations thereof. Another example of sulfur-based active material includes a sulfur-carbon composite. Selenium materials suitable for use as active material 16 can comprise elemental selenium, Li₂Se, selenium sulfide alloys, SeS₂, SnSeₓS_{y} (e.g., SnSe_{0.5}S_{0.5}) and combinations thereof. The chalcogen-based active material of the positive electrode 22′ may be intermingled with the polymer binder and the conductive filler. Suitable binders include polyvinylidene fluoride (PVDF), polyethylene oxide (PEO), an ethylene propylene diene monomer (EPDM) rubber, carboxymethyl cellulose (CMC)), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder material known to skilled artisans. Other suitable binders include polyvinyl alcohol (PVA), sodium alginate, or other water-soluble binders. The polymer binder structurally holds the chalcogen-based active material and the conductive filler together. An example of the conductive filler is a high surface area carbon, such as acetylene black or activated carbon. The conductive filler ensures electron conduction between the positive-side current collector 26 and the chalcogen -based active material. In an example, the positive electrode active material and the polymer binder may be encapsulated with carbon. In an example, the weight ratio of S and/or Se to C in the positive electrode 22′ ranges from 1:9 to 9:1.

The microporous polymer separator 18 can comprise, in one embodiment, a polyolefin. The polyolefin can be a homopolymer (derived from a single monomer constituent) or a heteropolymer (derived from more than one monomer constituent), either linear or branched. If a heteropolymer derived from two monomer constituents is employed, the polyolefin can assume any copolymer chain arrangement including those of a block copolymer or a random copolymer. The same holds true if the polyolefin is a heteropolymer derived from more than two monomer constituents. In one embodiment, the polyolefin can be polyethylene (PE), polypropylene (PP), or a blend of PE and PP. Separator 18 can optionally be ceramic-coated with materials including one or more of ceramic type aluminum oxide (e.g., Al₂O₃), and lithiated zeolite-type oxides, among others. Lithiated zeolite-type oxides can enhance the safety and cycle life performance of lithium ion batteries, such as battery cell 10.

The microporous polymer separator 18 may be a single layer or a multi-layer laminate fabricated from either a dry or wet process. For example, in one embodiment, a single layer of the polyolefin may constitute the entirety of the microporous polymer separator 18. As another example, however, multiple discrete layers of similar or dissimilar polyolefins may be assembled into the microporous polymer separator 18. The microporous polymer separator 18 may also comprise other polymers in addition to the polyolefin such as, but not limited to, polyethylene terephthalate (PET), polyvinylidene fluoride (PVdF), and or a polyamide (Nylon). The polyolefin layer, and any other optional polymer layers, may further be included in the microporous polymer separator 18 as a fibrous layer to help provide the microporous polymer separator 18 with appropriate structural and porosity characteristics. Skilled artisans will undoubtedly know and understand the many available polymers and commercial products from which the microporous polymer separator 18 may be fabricated, as well as the many manufacturing methods that may be employed to produce the microporous polymer separator 18.

In one embodiment, a lithium battery cell includes a cathode comprising LiNiₓCo_{y}Mn_{z}O₂ (e.g., LiNi_{0.6}Co_{0.2}Mn_{0.2}O₂), and an electrolyte comprising DMP. The electrolyte can optionally further include one or more co-solvents, in a DMP to collective co-solvent volume ratio of about 3:7 to about 7:3. Co-solvents can include one or more of tetrahydrofuran, 2-methyltetrahydrofuran and 1,3-dioxolane. The electrolyte can further comprise about 3.0M to about 6.0M dissolved LiN(FSO₂)₂. The lithium battery cell can comprise a lithium metal anode.

In one embodiment, a lithium battery cell includes a cathode comprising a sulfur active material (e.g., including sulfur, carbon, and one or more binders), and an electrolyte comprising DMP. The sulfur active material can include sulfur, carbon and a binder. The sulfur:carbon:binder weight ratio can be about 70:25:5 (+/−5 wt. % for each of the sulfur, carbon and binder). The binder can include one or more of PEO, PVDF, PVA, CMC, and SBR. The electrolyte can optionally further include one or more co-solvents, in a DMP to collective co-solvent volume ratio of about 3:7 to about 7:3. Co-solvents can include one or more of tetrahydrofuran, 2-methyltetrahydrofuran and 1,3-dioxolane. In one embodiment, the co-solvent comprises 1,3-dioxolane, and the volume ratio of DMP to 1,3-dioxolane is about 1:1 (+/−5 vol. % for each of the DMP and 1,3-dioxolane). The electrolyte can further comprise about 0.3M to about 0.5M, or about 4.0M dissolved LiN(FSO₂)₂ and about 0.5M to about 0.7M, or about 0.6M dissolved LiNO₃.

### EXAMPLE 1

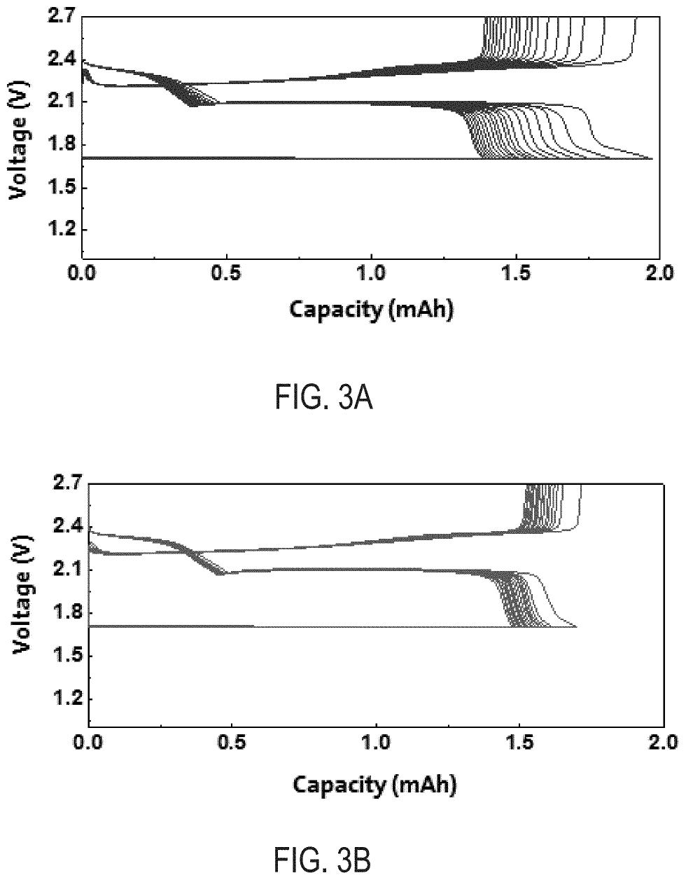

In order to compare the stability of DMP relative to DME, a common electrolyte solvent, two test battery cells were constructed with lithium anodes, and cathodes having active material comprising sulfur, carbon black, and a CMC polymer binder, in a 70:25:5 weight ratio, respectively. The electrolyte of the first test battery cell comprised 0.4M LiN(FSO₂)₂ and 0.6M LiNO₃ dissolved in DME and 1,3-dioxolane (with a 1:1 volume ratio of DME to 1,3-dioxolane). The electrolyte of the second test battery cell comprised 0.4M LiN(FSO₂)₂ and 0.6M LiNO₃ dissolved in DMP and 1,3-dioxolane (with a 1:1 volume ratio of DMP to 1,3-dioxolane). The first and second test battery cells were charged and discharged for 10 cycles. FIG. 3A illustrates the capacity decrease of the first (i.e., DME) test battery cell over the 10 cycles and FIG. 3B illustrates the capacity decrease of the second (i.e., DMP) test battery cell over the 10 cycles. The second test battery cell exhibits significantly lower capacity decrease than the first test battery cell, and indicates the superiority of DMP as an electrolyte solvent relative to DME.

### EXAMPLE 1

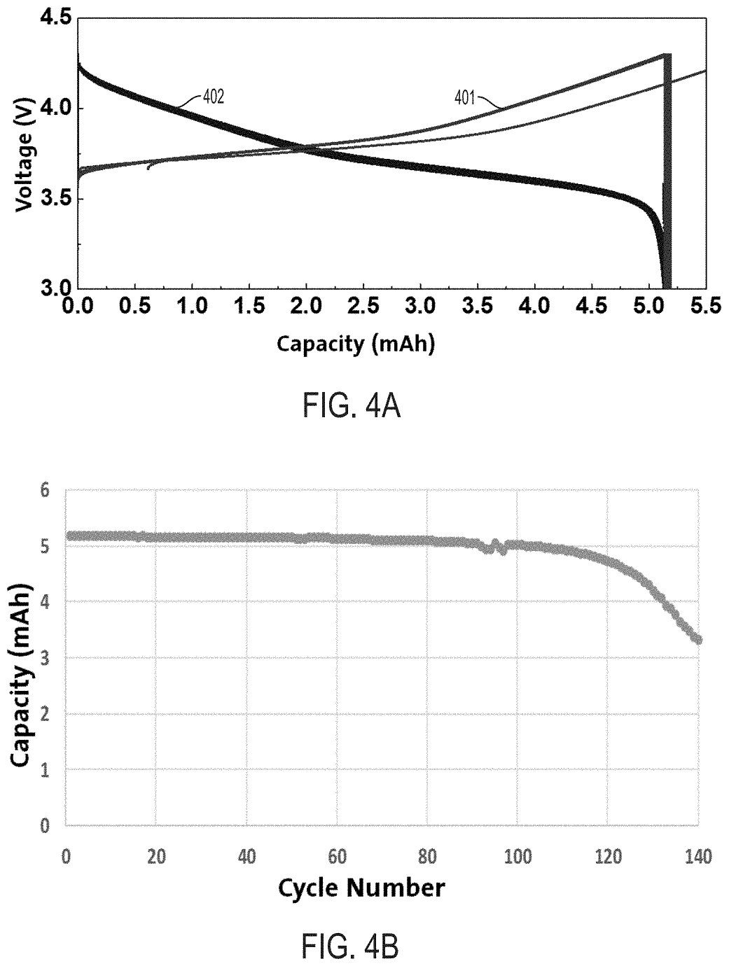

In order to demonstrate the multi-cycle performance of a battery cell utilizing a DMP electrolyte, a lithium battery cell was constructed with a 20 μm thickness lithium anode, a cathode active material comprising LiNi_{0.6}Co_{0.2}Mn_{0.2}O₂, and an electrolyte comprising 4.0 M LiN(FSO₂)₂ dissolved within DMP. The battery was cycled (i.e., charged and discharged) 140 times. FIG. 4A illustrates the charge voltage 401 and discharge voltage 402 for the 140 cycles. FIG. 4B illustrates the capacity of the battery cell relative to each cycle. FIG. 4B illustrates that the battery cell utilizing a DMP electrolyte can maintain a high capacity even after 140 cycles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A lithium battery cell, comprising:
an electrolyte comprising 1,3-dimethoxypropane;
an anode disposed within the electrolyte, wherein the anode comprises lithium; and
a cathode disposed within the electrolyte, wherein the cathode comprises a lithium metal oxide.

2. The lithium battery cell of claim 1, wherein the electrolyte further comprises a co-solvent.

3. The lithium battery cell of claim 2, wherein the co-solvent comprises one or more of tetrahydrofuran, 2-methyltetrahydrofuran and 1,3-dioxolane.

4. The lithium battery cell of claim 1, wherein the electrolyte further comprises a lithium salt.

5. The lithium battery cell of claim 4, wherein the lithium salt comprises LiN(FSO₂)₂.

6. The lithium battery cell of claim 4, wherein the lithium salt comprises one or more of LiClO₄, LiAlCl₄, LiI, LiBr, LiSCN, LiBF₄, LiB(C₆H₅)₄LiAsF₆, LiCF₃SO₃, LiN(CF₃SO₂)₂, and LiPF₆.

7. The lithium battery cell of claim 1, wherein the lithium metal oxide comprises LiNiₓCo_{y}Mn_{z}O₂.

8. The lithium battery cell of claim 1, wherein the lithium metal oxide comprises lithium iron phosphate.

9. The lithium battery cell of claim 1, wherein the electrolyte further comprises dissolved LiN(FSO₂)₂ and optionally a 1,3-dioxolane co-solvent, and the lithium metal oxide comprises LiNi_{0.6}Co_{0.2}Mn_{0.2}O₂.

10. A lithium-chalcogen battery cell, comprising:
an electrolyte comprising 1,3-dimethoxypropane;
an anode disposed within the electrolyte, wherein the anode comprises lithium; and
a cathode disposed within the electrolyte, wherein the cathode comprises a chalcogen material.

11. The lithium-chalcogen battery cell of claim 10, wherein the electrolyte further comprises a co-solvent.

12. The lithium-chalcogen battery cell of claim 11, wherein the co-solvent comprises one or more of tetrahydrofuran, 2-methyltetrahydrofuran and 1,3-dioxolane.

13. The lithium-chalcogen battery cell of claim 10, wherein the electrolyte further comprises a lithium salt.

14. The lithium-chalcogen battery cell of claim 13, wherein the lithium salt comprises LiN(FSO₂)₂.

15. The lithium-chalcogen battery cell of claim 13, wherein the lithium salt comprises one or more of LiClO₄, LiAlCl₄, LiI, LiBr, LiSCN, LiBF₄, LiB(C₆H₅)₄LiAsF₆, LiCF₃SO₃, LiN(CF₃SO₂)₂, and LiPF₆.

16. The lithium-chalcogen battery cell of claim 10, wherein the cathode comprises one or more sulfur materials and/or one or more selenium materials.

17. The lithium-chalcogen battery cell of claim 16, wherein the cathode further comprises a binder and a conductive filler.

18. The lithium-chalcogen battery cell of claim 10, wherein the electrolyte further comprises one or more of dissolved LiN(FSO₂)₂ and dissolved LiNO₃ and optionally a 1,3-dioxolane co-solvent, and the cathode comprises sulfur, carbon and a binder.

19. An electrolyte for a lithium ion battery comprising 1,3-dimethoxypropane (DMP).

20. The electrolyte of claim 19, further comprising one or more of tetrahydrofuran, 2-methyltetrahydrofuran and 1,3-dioxolane.
